(19) United States
(12) Patent Application Publication
(10) Pub. No.: US 2009/0222868 A1
(43) Pub. Date: Sep. 3, 2009

(54) SERVICE FOR PROVIDING SHARED MULTIMEDIA CONTENT

(75) Inventors: Douglas Reynolds, Austin, TX (US); Jeffrey Brandt, Cedar Park, TX (US); Marc Sullivan, Austin, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/040,703

(22) Filed: Feb. 29, 2008

(51) Int. Cl. H04N 7/173

(52) U.S. Cl. 725/104

(57) ABSTRACT

A multimedia content delivery resource suitable for supporting a video on demand service to a plurality of users substantially simultaneously. The multimedia content delivery resource includes a reception interface for receiving a video content item selection signal associated with a primary subscriber; and a subscriber selection signal indicative of a secondary subscriber associated with the primary subscriber; a shared video module operable to identify a selected video content item associated with the video content item selection signal and define recipients of the identified video content item based at least in part on the subscriber selection signal; and a transmission interface operable to transmit the identified video content item substantially simultaneously to the defined recipients.

### BACKGROUND

1. Field of the Disclosure

The present disclosure relates to multimedia content and more particularly to delivery of multimedia content by a service provider over a multimedia network.

2. Description of the Related Art

Service providers may provide their viewers with various services including services by which the viewers obtain television and other multimedia content, such as Video on Demand (VOD) and Pay Per View (PPV). In Internet Protocol (IP) based multimedia networks, “live” content is multicasted to multiple subscribers to conserve bandwidth usage while VOD and PPV are unicasted.

### BRIEF DESCRIPTION OF THE DRAWINGS

FIG. 1 is a block diagram of selected elements of an embodiment of a networked system for providing multimedia content delivery services;

FIG. 2 is block diagram of selected elements of an embodiment of a client suitable for use in a networked multimedia content delivery system of FIG. 1;

FIG. 3 is a block diagram of selected elements of an embodiment of a set top box suitable for use in the client of FIG. 2;

FIG. 4 is a block diagram of selected elements of an embodiment of a multimedia server suitable for use in the networked system of FIG. 1;

FIGS. 5A, 5B, 5C and 5D are flow diagrams of selected elements of an embodiment of a method and program for delivering shared multimedia content; and

FIG. 6 is a flow diagram of selected elements of an embodiment of a shared multimedia content service.

### DESCRIPTION OF THE EMBODIMENT(S)

The disclosed subject matter describes the use of a multimedia content delivery resource suitable for supporting a shared VOD service in which a plurality of users in different locations view VOD content substantially simultaneously. The multimedia content delivery resource includes a reception interface for receiving a video content item selection signal associated with a primary subscriber and a subscriber selection signal indicative of a secondary subscriber associated with the primary subscriber. A shared video module is operable to identify a selected video content item associated with the video content item selection signal and define recipients of the identified video content item based at least in part on the subscriber selection signal. A transmission interface is operable to transmit the identified video content item substantially simultaneously to the defined recipients.

In some embodiments of the multimedia content delivery resource, the primary system subscribers may pre-select other system subscribers from the plurality of system subscribers to display in a subscriber catalogue that lists all subscribers pre-selected by the primary system subscriber and/or their system status. In some embodiments of the multimedia content delivery resource, the system may include a module that charges an account associated with the primary subscriber when a video item content is selected, or may charge the primary and secondary subscribers when a video item content is shared. In some embodiments of the multimedia content delivery resource, the reception interface may allow the primary subscriber to generate a video cancel signal to end the video content item transmission. In some embodiments of the multimedia content delivery resource, the reception interface may, at any time, allow any of the linked subscribers to generate a subscriber cancel signal to cancel video content transmission to their receiver interface, or allow the primary receiver to cancel the video content transmission to other associated subscribers

In another embodiment, the disclosed multimedia server is operable to provide a video on demand service to a plurality of system subscribers in which a primary subscriber can select both a multimedia content item from a catalogue of multimedia content items and a secondary subscriber in which to associate, and a multimedia content delivery resource delivers the multimedia content item substantially simultaneously to a primary receiver associated with the primary subscriber and a secondary receiver associated with the secondary subscriber. In some embodiments, the catalogue of multimedia content may be pay per view items or video on demand items. In some embodiments, the server may enable the primary subscriber to pre-select a plurality of secondary subscribers from a subscriber catalogue, and the subscriber catalogue may include status information for each secondary subscriber, i.e., whether the secondary subscriber is connected to the multimedia server. The multimedia server may also be enabled to charge an account associated with the primary subscriber when the multimedia content is selected or both the primary and secondary subscribers if the multimedia content that is selected is shared. In other embodiments, the server may be enabled to allow the secondary subscriber to decline delivery of the selected multimedia content item or at any time cancel their association with the primary subscriber.

In other embodiments, the multimedia server may enable the multimedia content delivery resource to deliver the multimedia content item substantially simultaneously to a multicast group comprising the primary and the secondary subscribers. In such embodiments, the primary and secondary receivers are capable of responding to a playback event initiated by the primary subscriber, i.e., a fast forward event, a rewind event, or a stop or pause event.

In another aspect, a disclosed computer program product comprising computer executable instructions is stored on a tangible computer readable medium. The computer program product manages a plurality of subscribers to a video on demand system by transmitting a video catalogue to a primary subscriber, enabling the primary subscriber to associate with a secondary subscriber selected from a subscriber catalogue, enabling the primary subscriber to choose a video content item from the video catalogue, and transmitting the chosen video content item to the primary subscriber and the secondary subscriber substantially simultaneously. The computer program product may also include instructions to allow the primary subscriber to pre-select secondary subscribers to display in their subscriber catalogue, generate the subscriber catalogue so that the subscriber catalogue lists all secondary subscribers pre-selected by the primary system subscriber and their system status, charge an account associated with the primary and/or secondary subscribers when a video content item is selected, receive a video cancel signal and stop the transmission of the video content prior to charging the primary and/or secondary subscriber, and receive a subscriber cancel signal and stop the transmission of the video content to the secondary subscriber.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

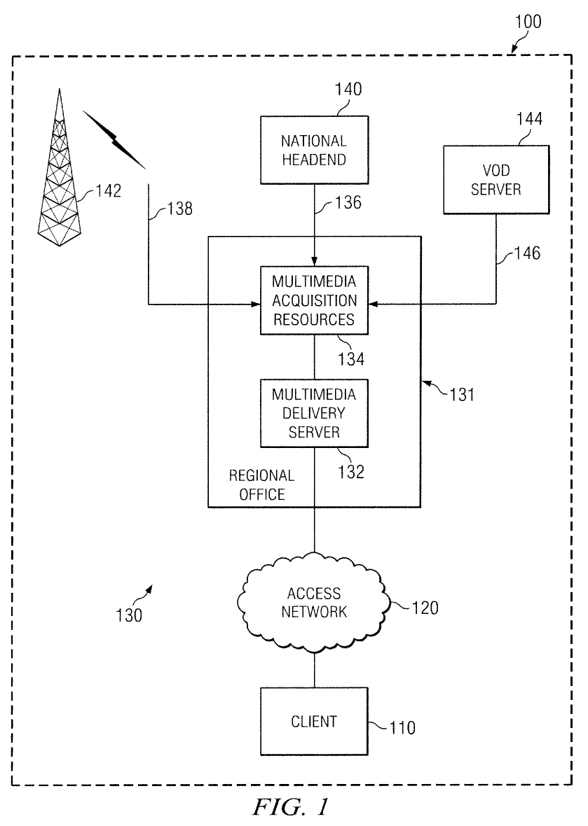

Turning now to the drawings, FIG. 1 is a block diagram of selected elements of a networked multimedia content distribution network 100, sometimes referred to herein simply as multimedia network 100. In the depicted embodiment, multimedia network 100 includes a client 110 connected to a multimedia service provider 130 by an intervening access network 120.

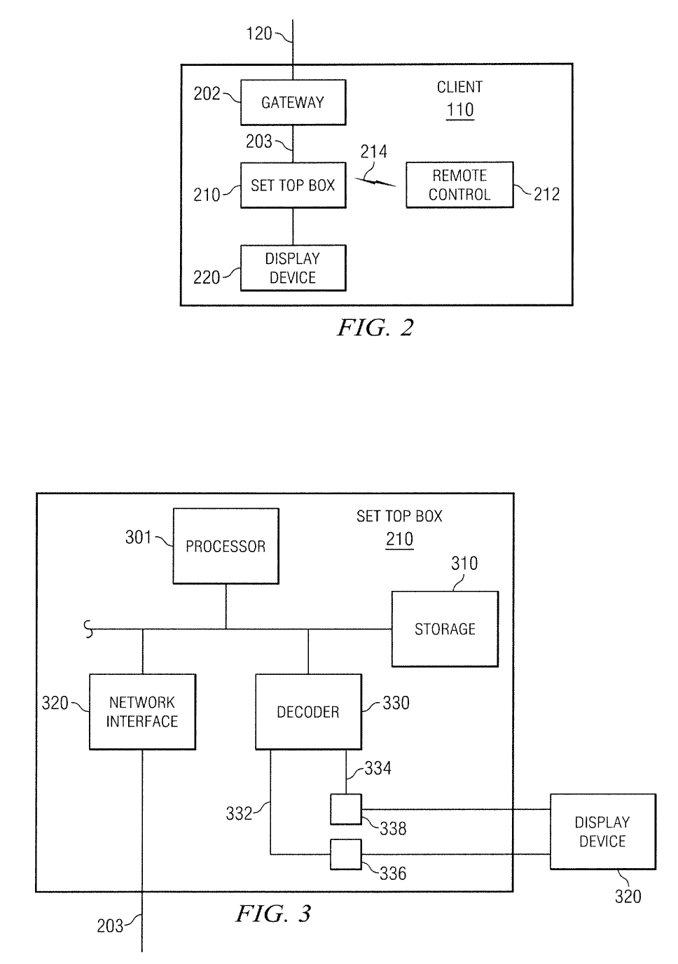

In some embodiments, client 110 represents premises equipment and/or applications used by a subscriber to multimedia services and/or a user or viewer of multimedia content. Referring to FIG. 2, a block diagram illustrates selected elements of an embodiment of client 110. In the depicted embodiment, client 110 includes a residential gateway 202, a set top box (STB) 210, and a display device 220. Residential gateway 202 may provide a firewall and/or routing functionality between a local area network (LAN) 203 to which STB 210 is connected and the access network 120. STB 210 is a special purpose data processing unit that may include, in addition to an embedded or general purpose microprocessor and storage, video processing elements including an audio/visual decoder module to process a stream of audio and video. Display device 220 encompasses any monitor, television, or display screen suitable for receiving audio/video content from remote control STB 210. In embodiments of client 110 that employ an IP-based or other packet switched access network 120, residential gateway 202 receives multimedia content as a series of packets or datagrams. The packets are assembled and otherwise processed within STB 210 and converted to analog signals suitable for presentation to display device 220.

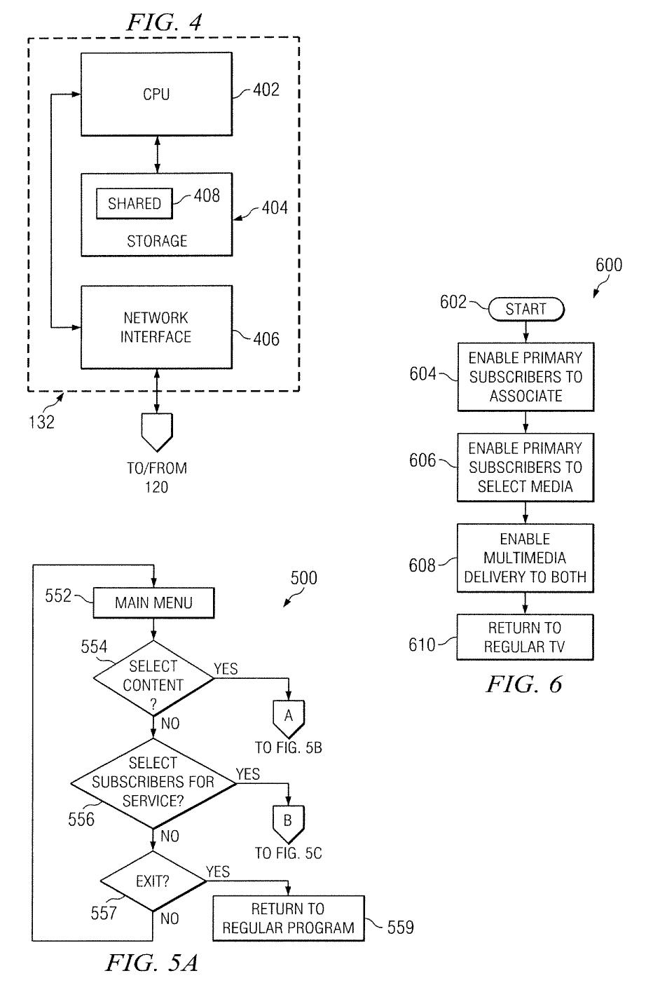

An embodiment of STB 210 is illustrated in FIG. 3. In the depicted implementation, STB 210 includes a processor 301 and general purpose storage 310 connected to a shared bus. A network interface 320 enables STB 210 to communicate with LAN 203. A decoder 330 integrates an audio and a visual decoder to generate native format audio signal 332 and video signals 334. Signals 332 and 334 are encoded and converted to analog signals by DAC/encoders 336 and 338. The output of DAC/encoders 336 and 338 is suitable for delivering to a National Television System Committee (NTSC), Phase Alternating Line (PAL), or another type of display screen.

Returning now to FIG. 1, some embodiments of multimedia service provider 130 encompass equipment and/or services used by an entity that provides multimedia services to one or more subscribers to multimedia service provider 130. As used in this disclosure, the terms “multimedia” and “multimedia content” encompass motion video content, whether live or pre-recorded, including conventional television programming content, VOD content, PPV content, and so forth. The depicted embodiment of multimedia service provider 130 has a hierarchical structure in which a plurality of regional offices receive multimedia content from one or a very limited number of national offices and supplement the nationally provided content with regional broadcast content. The regional offices, in turn, distribute content to subscribers over access network 120.

As depicted in FIG. 1, for example, multimedia service provider 130 includes a regional office 131. Regional office 131 as depicted in FIG. 1 includes multimedia acquisition resources 134 and a multimedia delivery server 132. Multimedia acquisition resources 134 encompass receivers, signal processors, and servers operable to receive multimedia content from one or more providers. As depicted in FIG. 1, for example, multimedia acquisition resources 134 receive national feed content 136 from a national headend 140 via a fiber optic or other form of high bandwidth backbone. National feed content 136 may include nationally distributed programming such as CNN, TNT, ESPN, and the like. Multimedia acquisition resources 134 as shown also receive regional content 138 from one or more regional broadcasters including the regional broadcaster 142 depicted in FIG. 1. Regional content 138 may include over-the-air broadcasted content from legacy broadcasters including NBC, ABC, CBS, FOX, and PBS. Multimedia acquisition resources 134 may further receive VOD content 146 from a locally or remotely located VOD server 144.

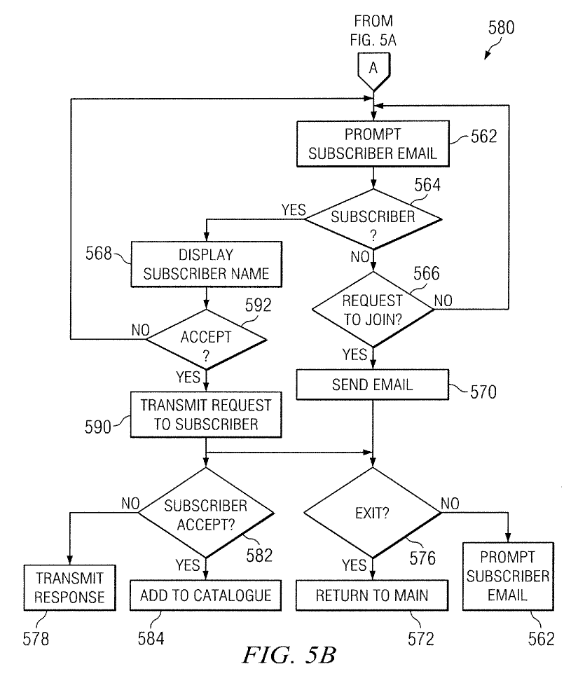

Multimedia delivery server 132 processes requests from clients 110 to provide route requested content to the requesting client or clients. Referring to FIG. 4, a block diagram illustrates selected elements of an embodiment of multimedia delivery server 132. In the depicted embodiment multimedia delivery server 132 includes a general purpose CPU 402 programmed to process subscriber requests and route selected multimedia content from storage 404 or multimedia acquisition resources 134 to access network 120, storage 404, including a shared content module 408, for saving multimedia content to be shared by clients, and network interface 406 for connecting the multimedia delivery server 132 with access network 120 and multimedia acquisition resources 134. Storage 404 may store VOD content accessed from the VOD server 144, pre-broadcast programming, i.e., digital video recordings, etc., to be shared amongst system subscribers. In IP-based implementations of access network 120, multimedia delivery server 132 may allow for sharing the multimedia content stored in storage 404 or obtained from multimedia acquisition resources 134, including VOD content, among multiple subscribers. Multimedia delivery server 132 may support unicasting VOD content to a requesting client.

Multimedia delivery server 132 may also include, as part of network interface 406, resources to encode and/or format multimedia content so that the resulting content is suitable for transmission over access network 120. For example, multimedia delivery server 132 may employ a pervasive or proprietary coder/decoder (codec) to compress and/or encrypt content prior to transmission. Compression is widely used for multimedia content transmission and storage to reduce the amount of data that must be transmitted over the network or stored in memory, disk, or another storage resource.

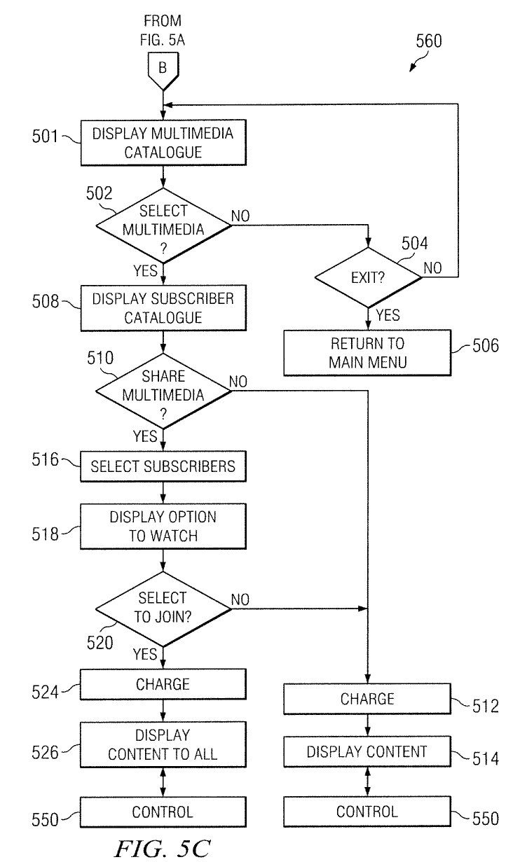

Referring now to FIG. 5A, a flow diagram illustrates an embodiment of a method and program that supports the sharing of multimedia content among multiple subscribers. Upon initializing the service 500, a main menu is routed to a display device 220 in client 110 of a primary subscriber (block 552). The main menu allows the primary subscriber to select multimedia content from a multimedia catalogue (block 554), select subscribers to include in a subscriber catalogue (block 556), or exit the menu. If the primary subscriber elects to exit the menu (block 557), the primary subscriber reverts to receiving the multimedia content the primary subscriber was viewing prior to entering the main menu (block 559).

Referring now to FIG. 5C, if the primary subscriber selects to view multimedia content in a multimedia catalogue, the multimedia catalogue is provided to the primary subscriber through the display device 220 in client 110 (block 501), and the primary subscriber is given the option to select a multimedia content item from the multimedia catalogue (block 502). If the primary subscriber does not select a multimedia content item, the primary subscriber is given the option to exit the multimedia catalogue display (block 504) and return to a main menu (block 506). If the primary subscriber selects a multimedia item, a subscriber catalogue is then displayed to the primary subscriber through display device 220 in client 110 (block 508). The primary subscriber then determines other subscribers for which to share the selected multimedia content item (block 510). If no other subscribers are selected, the service 500 charges the subscriber's account if there is a fee associated with the multimedia content item (block 512) and displays the selected content (block 514).

If the primary subscriber chooses to share the multimedia content with other subscribers, the primary subscriber selects the other subscribers from the subscriber catalogue (block 516), and an invitation to join in viewing the multimedia content item is displayed to the selected subscribers (block 518). If one or more of the other subscribers elect to join in viewing the multimedia content item (block 520), the primary subscriber is charged and the other subscribers may be charged for the multimedia content item (block 524). Finally, the multimedia content item is displayed to the first subscriber and the other subscribers that have joined in the viewing of the multimedia content item (block 526). As can be seen in FIG. 5C, each of the subscribers have the ability to control playback of the multimedia content (block 550). Referring to FIG. 5D, elements of an embodiment of multimedia control 550 are depicted. When a multimedia content item is viewed by each subscriber, multimedia control 550 is initialized (block 529). Multimedia control 550 verifies that a multimedia content item is still being viewed by the subscriber (block 530), and if the subscriber is no longer viewing the content, multimedia control 550 returns to the main menu (block 528). If content is still being viewed by the subscriber, the subscriber can cancel the display of the multimedia content item (block 552) and return to the main menu (block 532), fast forward the multimedia content item (blocks 534 and 536), rewind the multimedia content item (blocks 537 and 538), stop or pause playing the multimedia content item (blocks 539 and 542), and resume playing (unpause) the multimedia content item after it has been stopped/paused, advanced, or rewound (block 544). In other embodiments, alternative or additional control actions may be supported. These alternative or additional control actions may include, as examples, skipping ahead to a next chapter or to a bookmarked or otherwise specified location and skipping back to a previous chapter or to a previous bookmark or otherwise specified location. In this shared environment, control actions by any of the subscribers controls the playback for all of the subscribers.

Referring now to FIG. 5B, an embodiment of a subscriber catalogue selection process 580 is illustrated. In the depicted embodiment, once a primary subscriber initializes the catalogue selection process 580, the primary subscriber is asked to enter a requested subscriber email address (block 562), and the subscriber catalogue selection process 580 determines whether the email address corresponds to a current service subscriber (block 564). If not, the primary subscriber is asked whether or not they would like to send an invitation to join the service 500 to the email address provided (block 566) and if so, the subscriber selection process 580 sends the email (block 570). If the primary subscriber elects not to send the email, the catalogue selection process 580 returns to the prompt for a requested subscriber email address. Once the primary subscriber enters an email address corresponding to a current subscriber, the selected subscriber name is displayed and the primary subscriber is given to option to accept the selected subscriber as part of their subscriber catalogue (blocks 568 and 592). If the primary subscriber accepts, a subscriber catalogue request is transmitted to the selected subscriber (block 590), and the selected subscriber is given the option to decline the request (block 582). If the selected subscriber agrees to be included in the primary subscriber's subscriber catalogue, the primary subscriber's catalogue is updated (block 584). If the selected subscriber elects to decline the request, the response is transmitted to the primary subscriber (block 578). After each email is sent in step 570 or request is sent in step 590, the primary subscriber is given to option to return to the main menu (blocks 576 and 572) or to return to the email prompt (block 562).

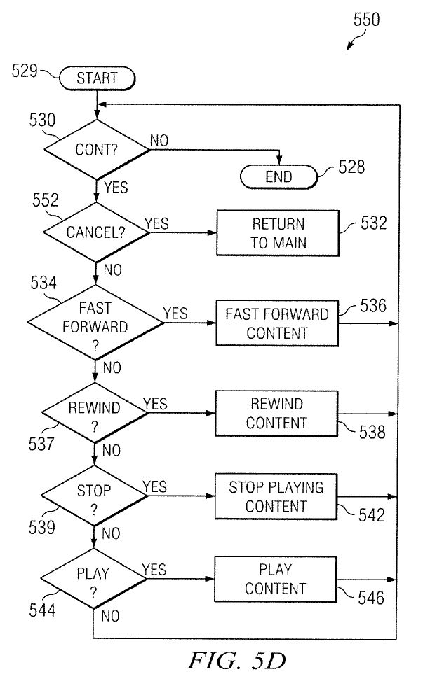

Referring now to FIG. 6, a flow diagram illustrates an embodiment of a shared multimedia content service 600. As can be seen, the depicted embodiment of service 600 includes enabling (block 604) a primary subscriber to associate with a secondary subscriber. When the primary subscriber has selected a secondary subscriber to associate with, service 600 includes enabling (block 606) the primary subscriber to select a multimedia content from a group or catalogue of multimedia content. When the multimedia content is selected, service 600 includes enabling (block 608) receivers associated with the primary subscriber and the secondary subscriber to receive multimedia content substantially simultaneously. The service 600 returns (block 610) to regular television programming after the multimedia content has been displayed.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A multimedia content delivery resource suitable for supporting a video on demand service comprising:
a reception interface for receiving:
a video content item selection associated with a primary subscriber; and
a subscriber selection indicative of a secondary subscriber associated with the primary subscriber;
a shared video module operable to identify a selected video content item associated with the video content item selection and define recipients of the identified video content item based at least in part on the subscriber selection; and
a transmission interface operable to transmit the identified video content item substantially simultaneously to the defined recipients.

2. The multimedia content delivery resource of claim 1, wherein the subscriber selection is generated when a primary subscriber selects other system subscribers from the plurality of system subscribers displayed in a subscriber catalogue.

3. The multimedia content delivery resource of claim 2, wherein the primary subscriber pre-selects subscribers in the subscriber catalogue and the subscriber lists all subscribers pre-selected by the primary subscriber and their system status.

4. The multimedia content delivery resource of claim 1, wherein the primary subscriber is charged.

5. The multimedia content delivery resource of claim 4, wherein the reception interface allows the primary subscriber to generate a video cancel signal to cancel the transmission of the video content item.

6. The multimedia content delivery resource of claim 1, wherein the reception interface allows the secondary subscribers to generate a subscriber cancel signal to cancel the video content transmission to the second subscriber.

7. The multimedia content delivery resource of claim 6, wherein the subscriber cancel signal can be generated at any time during the video content transmission.

8. The multimedia content delivery resource of claim 1, wherein the primary subscriber and the secondary subscriber control the video content, said control including a selection of fast forwarding, rewinding, stopping, pausing, unpausing, skipping ahead, and skipping back.

9. A method of providing a video on demand service to a plurality of system subscribers comprising:
enabling a primary subscriber to associate with a secondary subscriber;
enabling the primary subscriber to select a multimedia content item from a catalogue of multimedia content items; and
enabling a multimedia content delivery resource to deliver the multimedia content item, substantially simultaneously, to a primary receiver associated with the primary subscriber and to a secondary receiver associated with the secondary subscriber.

10. The method of claim 9, wherein enabling the primary subscriber to associate with the secondary subscriber comprises enabling the primary subscriber to select the secondary subscriber from a subscriber catalogue identifying a plurality of associated system subscribers.

11. The method of claim 10, wherein the subscriber catalogue lists all secondary subscribers pre-selected by the primary subscriber and their system status.

12. The method of claim 9, further comprising charging an account associated with the primary subscriber.

13. The method of claim 12, further comprising enabling the secondary subscriber to decline delivery of the selected multimedia content item prior to the charging of the account associated with the secondary subscriber.

14. The method of claim 10, further comprising enabling the secondary subscriber to cancel its association with the primary subscriber.

15. The method of claim 14, wherein the secondary subscriber can cancel its association at any time.

16. The method of claim 9 wherein enabling the multimedia content delivery resource to deliver the multimedia content item substantially simultaneously comprises enabling the multimedia content delivery resource to multicast the multimedia content item to a multicast group comprising the primary and the secondary subscribers.

17. The method of claim 9, further comprising, enabling the primary and secondary receivers to respond to a playback event initiated by the primary subscriber.

18. The method of claim 9, wherein the catalogue of multimedia content items comprise a catalogue of video on demand content items.

19. The method of claim 9, wherein the catalogue of multimedia content items comprise a catalogue of pay per view content items.

20. A computer program product comprising computer executable instructions, stored on a tangible computer readable medium, for managing a plurality of subscribers to a video on demand system, the instructions comprising instructions to:
transmit a video catalogue to a primary subscriber;
enable the primary subscriber to associate with a secondary subscriber selected from a subscriber catalogue;
enable the primary subscriber to choose a video content item from the video catalogue; and
transmit the chosen video content item to the particular subscriber and the secondary subscriber substantially simultaneously.

21. The computer program product of claim 20, further comprising instructions to allow the primary subscriber to pre-select other system subscribers to display in their subscriber catalogue.

22. The computer program product of claim 21, further comprising instructions to generate the subscriber catalogue so that the subscriber catalogue lists all subscribers pre-selected by the primary subscriber and their system status.

23. The computer program product of claim 20, further comprising instructions to charge an account associated with the primary subscriber when a video select signal is received.

24. The computer program product of claim 20, further comprising instructions to:
receive a video cancel signal; and
stop the video content transmission in response thereto.

25. The computer program product of claim 20, further comprising instructions to
receive a subscriber cancel signal; and
stop the video content transmission to the subscriber

26. The computer program product of claim 20, wherein the secondary subscriber cancel signal can be generated at any time during the video content transmission.
